(19) United States
(12) Patent Application Publication
(10) Pub. No.: US 2004/0197183 A1
(43) Pub. Date: Oct. 7, 2004

(54) Exchanger for tray feeder

(76) Inventors: Jae Hyuk Cho, Seongnam-si (KR); Sang Won Lee, Seongnam-si (KR); Dong Suh Lee, Seoul (KR)

Correspondence Address: FLESHNER & KIM, LLP, P.O. BOX 221200, CHANTILLY, VA, 20153, US

(21) Appl. No.: 10/795,509

(22) Filed: Mar. 9, 2004

Related U.S. Application Data
(63) Continuation-in-part of application No. 10/061,410, filed on Feb. 4, 2002, now abandoned.

(30) Foreign Application Priority Data
Jun. 22, 2001 (KR) 2001-35776

(51) Int. Cl. B65G 1/00

(52) U.S. Cl. 414/752.1

(57) ABSTRACT

An exchanger for a tray feeder is provided which can easily and stably grasp and move a tray plate loaded with electronic parts using a suction force. A plurality of vacuum pads are provided on a moveable nozzle support unit of the exchanger. The vacuum pads are mounted on a plurality of suction nozzles along the surface of the nozzle support unit. A plurality of stoppers are interspersed between pairs of adjacent suction nozzles. These stoppers stably and precisely position the tray plate while it is grasped by the suction nozzles and moved through the action of the nozzle support unit.

This application is a continuation-in-part of U.S. patent application Ser. No. 10/061,410, which claims priority to Korean Patent Application No. 35776/2001 filed Jun. 22, 2001.

### BACKGROUND OF THE INVENTION

1. Field of the Invention

The present invention relates to an exchanger for a tray feeder, and in particular to an improved exchanger for a tray feeder which can retrieve or return a tray on which an electronic part is mounted to or from a magazine.

2. Background of the Related Art

Referring to FIGS. 1 and 2, in a conventional electronic parts feeder for feeding electronic parts on a tray, a magazine 3 receiving the electronic parts 4 is supported by a lifter 7, and is lifted or lowered along a ball screw 6 driven by a driving motor 5.

When a required type of electronic parts 4 is selected, the lifter 7 is moved in an upward or downward direction. The magazine 3 receiving a tray plate 2 is supported on the lifter 7. After a position of the lifter 7 is decided, the tray plate 2 received in the magazine 3 is grasped and transferred by driving of a tray plate fetch unit 8.

Thereafter, the electronic parts 4 are moved to the upper portion of a centering table 11 by a moving unit 10 having a moving nozzle 9. The centering table 11 on which the electronic parts 4 are placed is moved to the mounter side, thereby supplying the electronic parts 4.

However, the conventional electronic parts feeder has a disadvantage in that, when the tray plate fetch unit 8 is driven to grasp and fetch the tray plate 2 received in the magazine 3 during the operation of the mounter, the tray plate 2 received in the magazine 3 can not maintain a constant position due to a shaking action caused by the driving of the electronic parts feeder. As a result, the tray plate fetch unit 8 incompletely or imprecisely grasps the tray plate 2, and thus the electronic parts 4 mounting process cannot be properly performed.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

Another object of the present invention is to provide an exchanger for a tray feeder which can easily grasp a tray plate loaded with electronic parts using a suction force applied by a plurality of vacuum pads of a nozzle support unit, which can stably and precisely position the tray plate while it is grasped and moved, and which can stably and precisely replace the tray plate.

In order to achieve the above-described object of the invention, there is provided (claim language)

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings, in which like reference numerals refer to like elements, and wherein:

FIG. 1 is a perspective view of a tray and a magazine of an electronic parts feeder in accordance with the conventional art;

FIG. 2 is a perspective view of an electronic parts feeder in accordance with the conventional art;

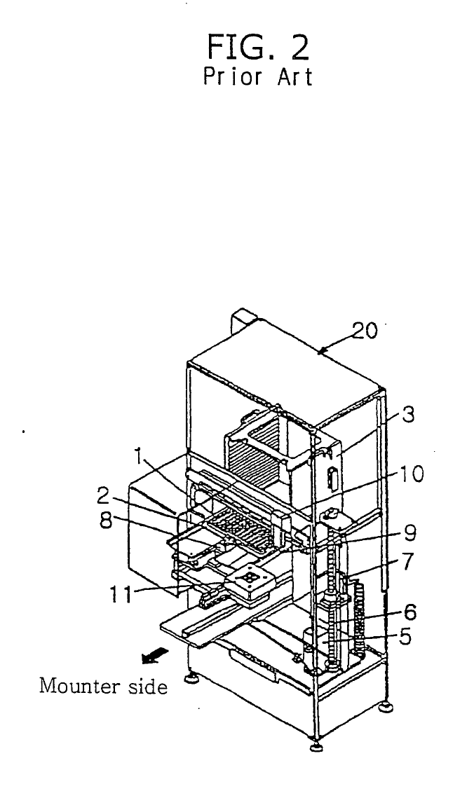

FIG. 3 is a perspective view of a tray feeder having an exchanger in accordance with an embodiment of the present invention;

FIG. 4 is a rear-perspective view of a main frame of the tray feeder of FIG. 3;

FIG. 5 is a perspective view of the exchanger of FIG. 3; and

FIG. 6 is a perspective view of a nozzle support unit of the exchanger shown in FIG. 5.

### DETAILED DESCRIPTION OF PREFERRED EMBODIMENTS

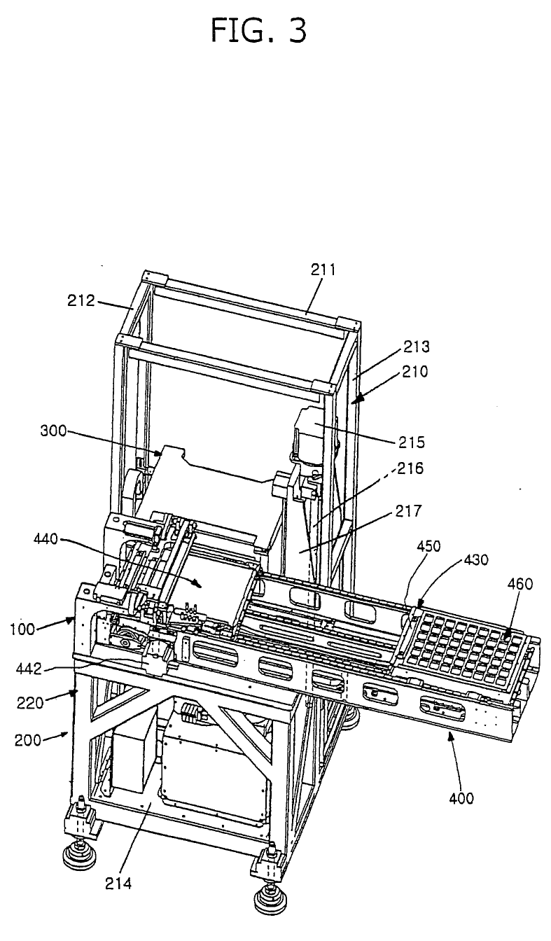

An exchanger for a tray feeder in accordance with an embodiment of the invention will now be described in detail with reference to FIGS. 3 to 5.

The tray feeder (referred to as ‘electronic parts feeder’) of the present invention includes an exchanger 100 for retrieving or replacing a plurality of tray plates 450, a stacker 200, a magazine 300 and a transfer 400. The stacker 200 includes a cover frame 210 and a main frame 220. The cover frame 210 has a plurality of horizontal frames 211, longitudinal frames 212 and vertical frames 213 surrounding an outer portion thereof A base unit 214 is formed at the lower portion of the vertical frames 213.

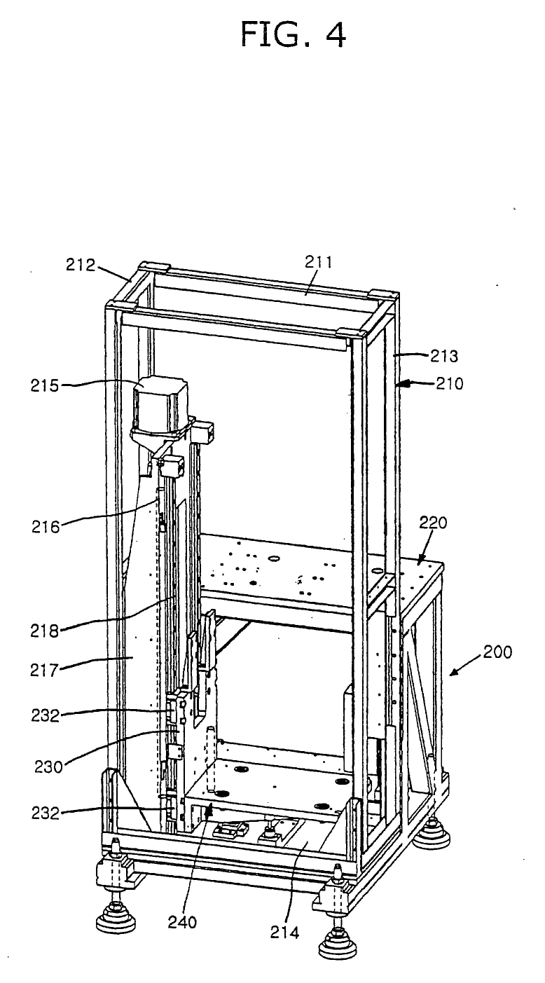

As illustrated in FIGS. 3 and 4, the transfer 400 and the exchanger 100 are connected at the upper portion of the main frame 220 positioned at one side portion of the cover frame 210. A motor 215 is installed at one side portion of the upper portion of a support frame 217, which is positioned at one side portion of the main frame 220. A ball screw 216 is connected to a motor shaft (not shown) of the driving motor 215. Since the ball screw 216 is connected to one side portion of an elevator 240, when the ball screw 216 is operated by driving the driving motor 215, the elevator 240 moves in a predetermined direction.

A plurality of Linear Motion (LM) guides 218 for guiding the elevator 240 positioned on the base unit 214 are installed at one side portion of the support frame 217. A plurality of guide blocks 232 connected to one side portion of the elevator 240 are inserted into the plurality of LM guides 218. Other portions of the guide blocks 232 are connected to one side portion of the guide frame 230 connected to the elevator 240, thereby lifting or lowering the elevator 240.

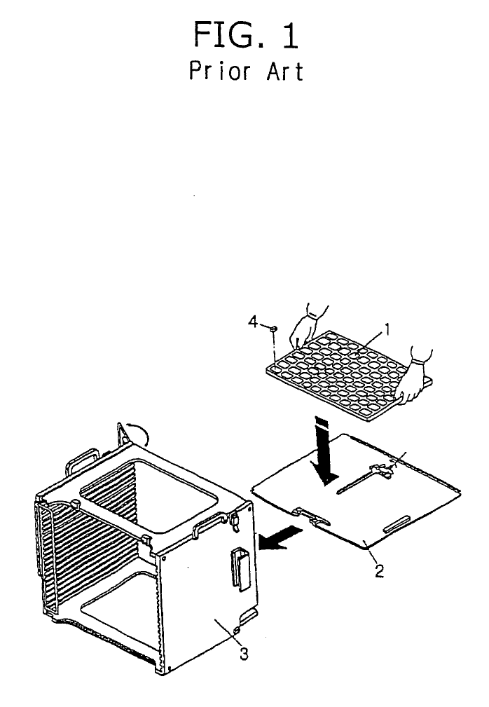

A plurality of electronic parts (see FIG. 1) are mounted on the plurality of trays 460 in the magazine 300. The plurality of trays 460 are mounted on a plurality of tray plates 450. First and second plates 430 and 440, respectively, for transferring the tray plates 450 are positioned at opposite end portions of the upper portion of the transfer 400 at a predetermined interval, and a driving unit 442 formed at one side portion of the transfer 400 to drive the first and second plates 430 and 440, respectively.

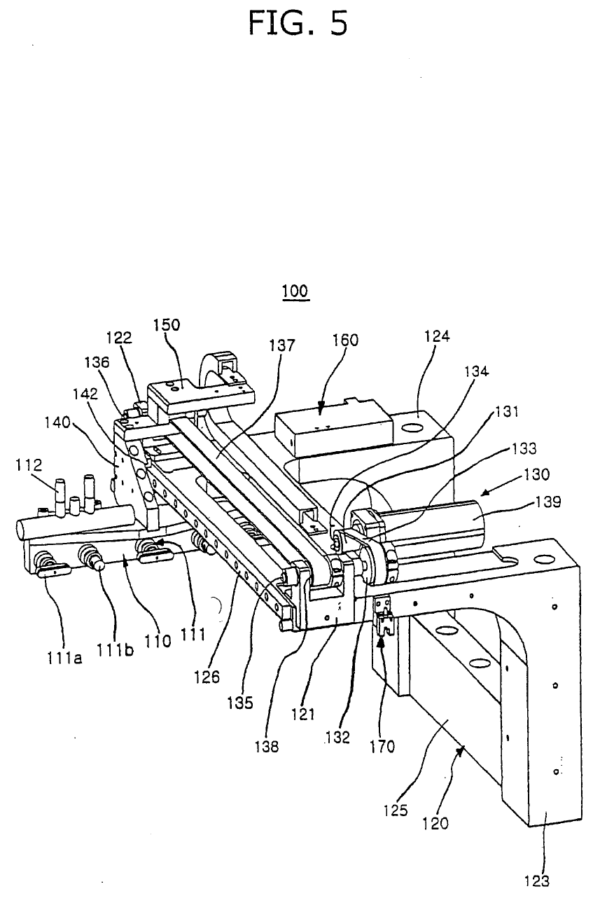

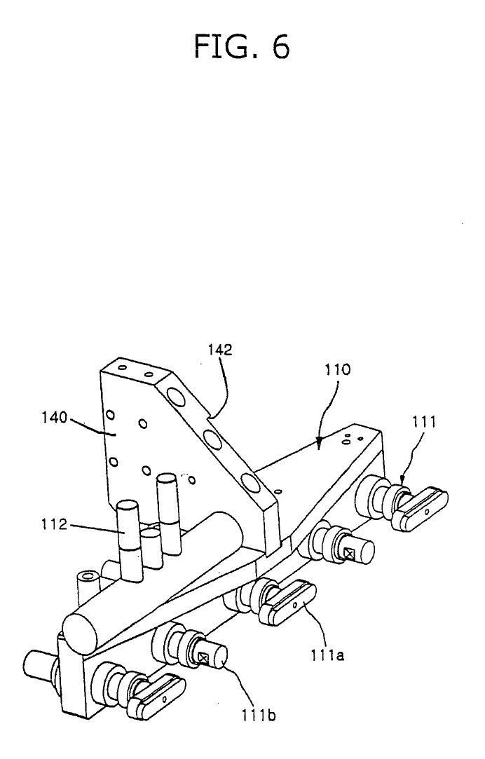

FIG. 5 is a perspective view illustrating the exchanger of FIG. 3, and FIG. 6 is an enlarged perspective view illustrating the nozzle support unit of the exchanger. The exchanger 100 includes a nozzle support unit 110, a guide support unit 120, a driving unit 130, a guide block 150, and a head block 140. The guide support unit 120 includes a first support frame 123 and a second support frame 124 positioned at both ends of the support frame 125. First and second support blocks 121 and 122 are respectively installed at an end portion of the first and second support frames 123 and 124. LM guides 126 are installed at end portions of the first and second support blocks 121 and 122.

A sensor unit 170 for sensing a position and distance of the tray plate 450 is formed at one side portion of the first support frame 123. The driving unit 130 for moving the nozzle support unit 110 is formed at the other side portion of the first support frame 123. A driving shaft 134 is connected to a motor 139 of the driving unit 130. A first belt 133 is wound around and positioned on a driving pulley 131 installed on the driving shaft 134, and an idle pulley 132 is installed on a first roller shaft 135.

A first roller 138 is connected to a portion of the first roller shaft 135, and a second roller (not shown) is connected to a portion of a second roller shaft 136. A second belt 137 is wound around first and second rollers. The first roller shaft 135 is inserted into the first support block 121 and the first roller 138. The second roller shaft 136 is inserted into the second roller, and the second roller shaft 136 supported by the second support block 122. The second support block 122 is formed at one end portion of the second support frame 124.

A vacuum generator 160 is installed on the second support frame 124. The vacuum generator is operatively connected to a manifold 112 formed at one side portion of the nozzle support unit 110. The guide block 150 is installed on the second belt 137, and performs a guiding operation with the head block 140 formed at the lower portion of the guide block 150. A guide groove 142 is formed at one side portion of the head block 140, so that the LM guide 126 can be inserted into the guide groove 142.

The nozzle support unit 110 is formed at the lower end portion of the head block 140. A plurality of nozzles 111 are supported in the nozzle support unit 110. A plurality of vacuum pads 111a for sucking one side portion of the tray plate 450, and a plurality of stoppers 111b for precisely and stably supporting and positioning a side portion of the tray plate 450 as it is sucked by the plurality of vacuum pads 111a are alternately formed on the plurality of nozzles 111, as shown in FIGS. 5 and 6. The manifold 112 is formed on the nozzle support unit 110, and transmits the vacuum force generated by the vacuum generator 160 to the plurality of vacuum pads 111a formed along a lower portion of the nozzle support unit 110. The vacuum generator 160 and the manifold 112 are connected through a hose (not shown) which allows the vacuum force generated by the vacuum generator 160 to be distributed to the plurality of vacuum pads 111a.

The operation of the exchanger for the tray feeder in accordance with the present invention will now be explained.

When the tray plate 450 transferred from the electronic parts feeder is received in the magazine 300, and the driving motor 215 installed at one side portion of the cover frame 210 of the tray feeder stacker 200 is driven, the elevator 240 is lifted along the LM guide 218 by rotation of the ball screw 216 connected to a driving shaft (not shown) of the motor 215. When the elevator 240 is lifted and stops at a predetermined position, the exchanger 100 is operated to retrieve a tray plate 450 from the magazine 300.

When the motor 139 of the driving unit 130 provided at one side portion of the guide support unit 120 of the exchanger 100 is driven and the driving shaft 134 connected to the motor 139 is rotated, the driving pulley 131 connected to the driving shaft 134 is rotated. The first belt 133 positioned in the driving pulley 131 is rotated, and the idle pulley 132 is rotated. The idle pulley 132 rotates the first roller shaft 135, which is inserted into the first roller 138. When the first roller 138 is rotated by the first roller shaft 135, the second belt 137 is rotated along the outer surfaces of the first and second rollers.

Because the guide block 150 is fixed on the second belt 137, the guide block 150 is moved in a forward direction along with the second belt 137, and the head block 140 and the nozzle support unit 110 connected to the guide block 150 are also moved in a forward direction. The manifold 112 formed on the nozzle support unit 110 receives the vacuum force generated by the vacuum generator 160 and distributes the vacuum force to the plurality of vacuum pads 111a. Thus, the plurality of vacuum pads 111a uses the vacuum force to suck and grasp support protrusions formed at one side portion of the tray plate 450.

When the driving pulley 131 is inversely rotated by inverse-driving of the motor 139 of the driving unit 130, the driving pulley 131 is inversely rotated, and the first belt 133 is rotated along the outer surfaces of the driving pulley 131 and the idle pulley 132, thereby inversely rotating the idle pulley 132.

When the first roller shaft 135 is inversely rotated, the first roller 138 inserted into the other end portion of the first roller shaft 135 is also inversely rotated, and thus the second belt 137 is inversely rotated along the outer surfaces of the first and second rollers. The inverse rotation of the second belt 137 moves the guide block 150 away from the magazine 300 towards a rear portion. The nozzle support unit 110, which is attached to the guide block 150 through the head block 140, also moves away from the magazine 300, while grasping the tray plate 450, thus extracting the tray plate 450 from the magazine 300.

When the suction force of the vacuum pads 111a is removed by the operation of the vacuum generator 160, the retrieved tray plate 450 is positioned on the second plate 440 positioned at the upper portion of the side of the transfer 400. The tray plate 450 is transferred to a mounter by the second plate 440 by driving of the transfer 400. At the same time, the first plate 430 positioned at the other side portion of the transfer 400 is returned to the exchanger side.

When the mounting operation is complete, the tray plate 450 is mounted on the first plate 430. A distance and position of the tray plate 450 are sensed by the sensor unit 170 provided at one side portion of the guide support unit 120. When the tray plate 450 stops at a predetermined position, the nozzle support unit 110 formed at one side portion of the exchanger 100 is operated to grasp the tray plate 450.

The tray plate 450 is received in the magazine 300, and then lowered with the magazine 300 by driving of the elevator 240, and electronic parts are loaded on the tray plate 450. Then, the tray plate 450 is received in the magazine 300 once again, and lifted with the magazine 300 to transfer the electronic parts to the mounter.

In accordance with the present invention, when the tray plate 450 on which the electronic parts are mounted is transferred, the sensor unit 170 provided at one side portion of the guide support unit 120 senses the position of the tray plate 450. In this manner, the tray plate 450 on which the tray 460 receiving the electronic parts is mounted can be stably and precisely positioned, held, moved, and released. More specifically, precise control of the vacuum force generated by the vacuum generator 160 and distributed to the plurality of vacuum pads 111a by the manifold 112 allows the nozzle support unit to firmly and precisely grasp, hold, and release the tray plate 450 as necessary. Additionally, the stoppers 111b provide for stable and precise positioning, movement, and release of the tray plate 450 by providing support to the side of the tray plate 450 so as to fix the tray plate 450 in place, stabilize the tray plate 450, and inhibit movement of the tray plate 450 beyond the plane of the stoppers 111b while the tray plate is held by the vacuum pads 111a.

As discussed earlier, in accordance with the present invention, the tray plate on which the electronic parts is mounted is firmly, stably, and precisely grasped by the operation of the tray feeder exchanger, and stably transferred to a predetermined position through the action of the vacuum pads and the stoppers, which results in improved workability, reliability and productivity.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the metes and bounds of the claims, or equivalences of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An exchanger for a tray feeder, comprising:
a support frame mounted on a tray feeder,
a nozzle support unit mounted on the support frame and configured to move between first and second positions, wherein the nozzle support unit comprises at least one suction nozzle configured to removably grasp a tray plate using a vacuum force, and at least one stopper configured to position and support the tray plate; and
a driver configured to move the nozzle support unit between the first and second positions.

2. The exchanger of claim 1, wherein the at least one stopper is mounted on the nozzle support unit proximate the at least one suction nozzle, and wherein the at least one stopper is configured to locate a tray plate relative to the nozzle support unit when the tray plate is being grasped by the at least one suction nozzle.

3. The exchanger of claim 2, wherein the at least one suction nozzle comprises a plurality of suction nozzles, and the at least one stopper comprises a plurality of stoppers, and wherein a stopper is located between each adjacent pair of suction nozzles.

4. The exchanger of claim 3, wherein each suction nozzle of the plurality of suction nozzles includes a flexible vacuum pad configured to abut a tray plate when the tray plate is grasped by the suction nozzle, and wherein each stopper of the plurality of stoppers is configured to limit movement of the tray plate relative to the nozzle support unit.

5. The exchanger of claim 1, further comprising a vacuum source mounted on the support frame and operatively coupled to the at least one suction nozzle.

6. The exchanger of claim 5, further comprising a manifold mounted on the nozzle support unit and configured to operatively couple the at least one suction nozzle and the vacuum source, wherein the manifold is configured to distribute a vacuum force from the vacuum source to the at least one suction nozzle.

7. The exchanger of claim 1, further comprising a linear motion guide mounted on the support frame, wherein the nozzle support unit is movable along the linear motion guide between the first and second positions.

8. The exchanger of claim 1, further comprising a sensor mounted on the support frame and configured to sense a position of a tray plate relative to the support frame.

9. The exchanger of claim 1, wherein the driver comprises:
a motor mounted on the support frame;
first and second drive rollers mounted on the support frame, wherein at least one of the first and second drive rollers is coupled to the motor such that it rotates with the motor; and
a guide belt mounted on the first and second drive rollers, wherein the nozzle support unit is attached to the guide belt such that movement of the guide belt moves the nozzle support unit between the first and second positions.

10. The exchanger of claim 9, further comprising a linear motion guide mounted on the support frame, wherein the nozzle support unit is mounted on the linear motion guide, and wherein movement of the guide belt causes the nozzle support unit to move along the linear motion guide.

11. The exchanger of claim 9, wherein the at least one stopper is mounted on the nozzle support unit proximate the at least one suction nozzle, and wherein the at least one stopper is configured to position and secure a tray plate relative to the nozzle support unit when the tray plate is being grasped by the at least one suction nozzle.

12. The exchanger of claim 11, wherein the at least one suction nozzle comprises a plurality of suction nozzles, and the at least one stopper comprises a plurality of stoppers, and wherein a stopper is located between each adjacent pair of suction nozzles.

13. The exchanger of claim 12, wherein each suction nozzle of the plurality of suction nozzles includes a flexible vacuum pad configured to abut a tray plate when the tray plate is grasped by the suction nozzle, and wherein each stopper is configured to limit movement of the tray plate relative to the nozzle support unit.

14. The exchanger of claim 13, further comprising a sensor mounted on the support frame and configured to sense a position of a tray plate relative to the support frame.

15. The exchanger of claim 14, further comprising a vacuum source mounted on the support frame and operatively coupled to the at least one suction nozzle.

16. The exchanger of claim 15, further comprising a manifold mounted on the nozzle support unit and configured to operatively couple the at least one suction nozzle and the vacuum source, wherein the manifold is configured to distribute a vacuum force from the vacuum source to the at least one suction nozzle.

17. An exchanger for a tray feeder configured to transfer and to exchange a tray plate, comprising:
first and second support frames;
a guide support unit installed between the first and second support frames;
a vacuum generator provided on one of the first and second support frames and configured to generate a vacuum force;
a nozzle support unit movably mounted on the guide support unit, comprising:
a manifold mounted on the nozzle support unit and operatively coupled to the vacuum generator;
a plurality of vacuum pads positioned along a surface of the nozzle support unit and operatively coupled to the manifold, wherein the manifold is configured to distribute the vacuum force generated by the vacuum generator to the plurality of vacuum pads; and
a plurality of stoppers configured to position a tray plate relative to the nozzle support unit;
a transfer device configured to move the nozzle support unit between first and second positions; and
a drive unit configured to drive the transfer device.

18. The exchanger of claim 17, wherein the transfer device comprises:
a linear motion guide configured to guide the nozzle support unit; and
a drive belt, mounted on first and second rollers, wherein the drive belt is connected to the nozzle support unit, and wherein the drive belt is driven by the drive unit.

19. The exchanger of claim 17, further comprising a sensor provided on a side of the support frame and configured to sense a position of a tray plate.

20. The exchanger of claim 17, wherein the nozzle support unit comprises a plurality of nozzles, and wherein each vacuum pad of the plurality of vacuum pads is mounted on a respective nozzle.
